(19) United States
(12) Patent Application Publication
(10) Pub. No.: US 2025/0189640 A1
(43) Pub. Date: Jun. 12, 2025

(54) OPTICAL MEASUREMENT DEVICE

(71) Applicant: Mitsubishi Electric Corporation, Tokyo (JP)

(72) Inventors: Takanori YAMAUCHI, Tokyo (JP); Nobuki KOTAKE, Tokyo (JP); Hiroki GOTO, Tokyo (JP); Masaharu IMAKI, Tokyo (JP); Naoki SONO, Tokyo (JP)

(73) Assignee: Mitsubishi Electric Corporation, Tokyo (JP)

(21) Appl. No.: 19/057,012

(22) Filed: Feb. 19, 2025

Related U.S. Application Data
(63) Continuation of application No. PCT/JP2022/037544, filed on Oct. 7, 2022.

(51) Int. Cl. G01S 7/4911; G01S 17/32

(52) U.S. Cl. CPC G01S 7/4911; G01S 17/32

(57) ABSTRACT

An optical measurement device includes: a wavelength sweeping light source that outputs swept light having a wavelength continuously changing with time; an irradiation optical system that emits measurement output light toward a measurement object, receives reflected light from the measurement object, and outputs the reflected light as measurement reflected light; a circulating light path that includes a loop portion and outputs circulating reference light for each circulation, in which reference output light caused by the swept light circulates through the loop portion N (an integer equal to or more than 0) times; a measurement signal acquisition unit that combines the measurement reflected light from the irradiation optical system and the circulating reference light from the circulating light path, outputs an accurate measurement signal, and rough measurement signals; and a signal processor unit that identifies the number of circulations in the circulating light path of the circulating reference light.

### CROSS REFERENCE TO RELATED APPLICATIONS

This application is a Continuation of PCT International Application No. PCT/JP2022/037544 filed on Oct. 7, 2022, all of which is hereby expressly incorporated by reference into the present application.

### TECHNICAL FIELD

The present disclosure relates to an optical measurement device.

### BACKGROUND ART

As a method for measuring a distance from a light source to an object using light emitted from the light source, a method such as a pulse propagation method, a triangulation method, a confocal method, a white interference method, or a wavelength scanning interference method is known.

Patent Literature 1 discloses a measurement device capable of expanding a measurement range without being limited by coherence specific to a light source using a wavelength scanning interference method among these methods.

The measurement device disclosed in Patent Literature 1 includes a circulating reference optical system including a 2×2 optical fiber coupler, an optical fiber, and a light path delay/selector, disposed between a 1×2 fiber directional coupler (coupler) and an interference 1×2 optical fiber coupler, and includes a measurement light path in which a measurement light output reaches a beam splitter from the coupler and measurement light reflected by a measurement object reaches the interference 1×2 optical fiber coupler from the beam splitter and a reference light path in which a reference light output reaches the circulating reference optical system from the coupler and circulating reference light reaches the interference 1×2 optical fiber coupler.

### CITATION LIST

### Patent Literature

Patent Literature 1: JP 2001-41706 A

### SUMMARY OF INVENTION

### Technical Problem

In the measurement device disclosed in Patent Literature 1, a refractive index of an optical fiber has temperature dependency. Therefore, a light speed in the optical fiber fluctuates by about several tens of μm/min depending on an environmental temperature, and light path lengths of the measurement light path and the reference light path, particularly, the light path length of the reference light path for each circulation is likely to fluctuate because the reference light path includes the circulating reference optical system, and measurement accuracy is likely to be affected by a temperature change.

The present disclosure has been made in view of the above points, and an object of the present disclosure is to provide a wavelength scanning interference type optical measurement device that can expand a measurement range, can enhance resistance to a temperature change, that is, is hardly affected by a change in environmental temperature, and can perform highly accurate measurement.

### Solution to Problem

An optical measurement device according to the present disclosure includes: a wavelength sweeping light source that outputs swept light having a wavelength continuously changing with time; an irradiation optical system that emits measurement output light caused by the swept light from the wavelength sweeping light source toward a measurement object into a space as measurement light, receives reflected light obtained by the measurement object reflecting the measurement light, and outputs the reflected light as measurement reflected light; a circulating light path that includes a loop portion and outputs circulating reference light for each circulation, in which reference output light caused by the swept light from the wavelength sweeping light source circulates through the loop portion N (an integer equal to or more than 0) times; a measurement signal acquirer that combines the measurement reflected light from the irradiation optical system and the circulating reference light from the circulating light path, outputs an accurate measurement signal obtained by photoelectrically converting the combined interference light, and outputs a plurality of rough measurement signals including electric signals obtained using a plurality of circulating number measurement light beams having different refraction index dependencies with respect to a light path on the basis of the swept light; and a signal processor that identifies the number of circulations in the circulating light path of the circulating reference light, in which a light path length difference between the measurement reflected light and the circulating reference light is obtained by the accurate measurement signal from the measurement signal acquirer, and a light path length difference between the measurement reflected light and the circulating reference light is obtained by the plurality of rough measurement signals from the measurement signal acquirer.

### Advantageous Effects of Invention

According to the present disclosure, even when a low coherence light source having a narrow measurement range is used, a distance to a measurement object can be measured with high accuracy while a measurement range is expanded and the measurement is hardly affected by a change in environmental temperature.

### BRIEF DESCRIPTION OF DRAWINGS

FIG. 1 is a configuration diagram illustrating an optical measurement device according to a first embodiment.

FIG. 2 is a schematic diagram illustrating a spectrum caused by measurement reflected light and a spectrum caused by end surface reflected light.

FIG. 3 is a schematic diagram illustrating a light path length caused by measurement reflected light, a light path length caused by circulating reference light in a first wavelength region, and a light path length caused by circulating reference light in a second wavelength region in the optical measurement device according to the first embodiment.

FIG. 4 is a schematic diagram illustrating a spectrum caused by the circulating reference light in the first wavelength region and a spectrum caused by the circulating reference light in the second wavelength region in the optical measurement device according to the first embodiment.

FIG. 5 is a schematic diagram illustrating a light intensity of a part of swept light before the swept light passes through an optical filter in the optical measurement device according to the first embodiment.

FIG. 6 is a schematic diagram illustrating a light intensity obtained by dividing a part of swept light after the swept light passes through the optical filter in the optical measurement device according to the first embodiment into k parts.

FIG. 7 is a schematic diagram illustrating a spectrum obtained by accurate measurement in the optical measurement device according to the first embodiment.

FIG. 8 is a schematic diagram illustrating a spectrum obtained by rough measurement in the optical measurement device according to the first embodiment.

FIG. 9 is a schematic diagram illustrating that a slope of a frequency of circulating reference light to time changes due to wavelength dispersion for each circulation of a loop in a loop portion in the optical measurement device according to the first embodiment.

FIG. 10 is a schematic diagram illustrating that a slope of a frequency of measurement reflected light to time changes due to wavelength dispersion for each circulation of a loop in a loop portion, which is another example, in the optical measurement device according to the first embodiment.

FIG. 11 is a configuration diagram illustrating an optical measurement device according to a second embodiment.

FIG. 12 is a configuration diagram illustrating a rough measurement signal acquisition unit in the optical measurement device according to the second embodiment.

FIG. 13 is a schematic diagram illustrating a light path length caused by measurement reflected light, a light path length caused by P-wave circulating reference light, and a light path length caused by S-wave circulating reference light in the optical measurement device according to the second embodiment.

FIG. 14 is a schematic diagram illustrating a spectrum caused by the P-wave circulating reference light and a spectrum caused by the S-wave circulating reference light in the optical measurement device according to the second embodiment.

FIG. 15 is a configuration diagram illustrating an optical measurement device according to a third embodiment.

FIG. 16 is a configuration diagram illustrating an optical measurement device according to a fourth embodiment.

### DESCRIPTION OF EMBODIMENTS

### First Embodiment

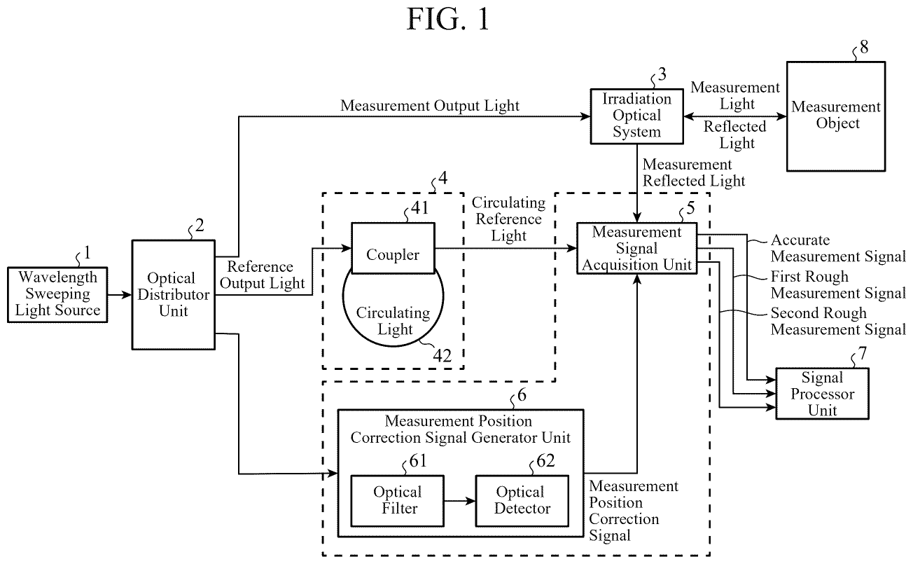

An optical measurement device according to a first embodiment will be described with reference to FIGS. 1 to 10.

The optical measurement device according to the first embodiment is an optical measurement device of a wavelength scanning interference method using a wavelength sweeping type optical coherence tomography (Swept Source-OCT (SS-OCT)).

The optical measurement device according to the first embodiment is an optical measurement device using a low coherence light source (hereinafter, referred to as a wavelength sweeping light source) having a short coherence length, for example, a coherence length of about 10 mm.

The low coherence light source is inexpensive but has a narrow measurement range.

The optical measurement device according to the first embodiment expands the measurement range by disposing a circulating light path in a reference light path.

The optical measurement device according to the first embodiment identifies the number of circulations of the circulating light path in reference output light using a plurality of rough measurement signals including electric signals obtained using a plurality of circulating number measurement light beams having different refractive index dependencies with respect to a light path on the basis of swept light from a wavelength sweeping light source.

The optical measurement device according to the first embodiment obtains a plurality of rough measurement signals using wavelength dependency of a refractive index derived from a light propagation medium in the reference light path, so-called wavelength dispersion, and identifies the number of circulations of the circulating light path in reference output light using the obtained plurality of rough measurement signals.

The optical measurement device according to the first embodiment generates a plurality of rough measurement signals by utilizing a fact that a shift amount of a beat frequency with respect to each of light beams of different frequencies is proportional to the number of circulations of the circulating light path and the wavelength dependency of a refractive index, and identifies the number of circulations of the circulating light path in the reference output light using the plurality of generated rough measurement signals.

The optical measurement device according to the first embodiment generates a plurality of rough measurement signals using beat frequencies of circulating number measurement light beams in different wavelength regions within a sweep range of swept light from a wavelength sweeping light source 1, and identifies the number of circulations of the circulating light path in the reference output light using the plurality of generated rough measurement signals.

Note that the light path length is proportional to a product of the length of a light propagation medium and a refractive index, the beat frequency is proportional to the light path length, and a difference between light path lengths having different wavelength dependencies of a refractive index is proportional to the number of circulations of the circulating light path.

As illustrated in FIG. 1, the optical measurement device according to the first embodiment includes the wavelength sweeping light source 1, a light dividing unit 2, an irradiation optical system 3, a circulating light path 4, a measurement signal acquisition unit 5, a measurement position correction signal generator unit 6, and a signal processor unit 7.

Note that the measurement position correction signal generator unit 6 is illustrated as a component separate from the measurement signal acquisition unit 5 for convenience of description of the embodiment, but is one element of the measurement signal acquisition unit 5.

The wavelength sweeping light source 1 includes a laser light source and a sweeping unit. The sweeping unit continuously changes a wavelength of laser light of a single frequency from the laser light source with respect to time, and outputs (emits) swept light that is wavelength-swept laser light.

The wavelength sweeping performed by the sweeping unit may use a method for simultaneously sweeping a plurality of wavelengths like TROSA used in optical information communication.

The swept light is desirably swept linearly with respect to time, and the time and the wavelength desirably have a 1:1 relationship.

Note that, even when the swept light is swept nonlinearly with respect to time, it is only required for the measurement signal acquisition unit 5 and the signal processor unit 7 to compensate the nonlinearity. As a technique for compensating the nonlinearity, it is only required to use a generally known technique.

When a plurality of (N) circulations is defined as one cycle, the swept light is emitted from the sweeping unit in each cycle, and one emission time is longer than a time between circulations and shorter than two circulations.

The wavelength sweeping light source 1 is a light source having a short coherence length, and has a coherence length of about 10 mm, for example.

The wavelength sweeping light source 1 continuously changes a wavelength within a sweep range with respect to time, and emits swept light that is wavelength-swept laser light, for example, swept light having a center wavelength of 1550 nm and a sweep range of 100 nm having a wide sweep band.

Note that, in the wavelength sweeping light source 1, the sweeping unit may continuously change a plurality of wavelength regions having different wavelength regions within a sweep range in a time-multiplexed manner, and emit swept light that is laser light wavelength-swept to light in a plurality of wavelength regions, for example, swept light having a center wavelength of substantially 1550 nm and a sweep range of 100 nm having a wide sweep band, obtained by sweeping 20 swept light beams each having a wavelength shifted by 5 nm from 1550 nm as a center.

The light dividing unit 2 receives, as an input, the swept light from the wavelength sweeping light source 1 via an optical fiber, and divides the swept light into measurement output light and reference output light. A dividing ratio between the measurement output light and the reference output light is set depending on various conditions, but it is desirable to set a large dividing ratio to the measurement output light in such a manner that the measurement object 8 can be measured even when the measurement object 8 is has a low reflectance.

The light dividing unit 2 is a coupler that is a 1×2 fiber directional coupler.

The optical fiber is a commonly used single mode fiber. An optical fiber connecting components described below is also a single mode fiber.

The irradiation optical system 3 receives, as an input, the measurement output light from the light dividing unit 2 via an optical fiber, emits the measurement output light as measurement light into a space toward the measurement object 8, receives reflected light obtained by the measurement object 8 reflecting the measurement light, and outputs the reflected light as measurement reflected light.

The irradiation optical system 3 includes an optical circulator, a condenser lens, and a connector.

The optical circulator outputs the measurement output light from the light dividing unit 2 to the condenser lens as measurement light, receives reflected light obtained by the measurement object 8 reflecting the measurement light, and outputs the reflected light to the measurement signal acquisition unit 5 as measurement reflected light.

The optical circulator and the light dividing unit 2 are connected to each other by an optical fiber, and the optical circulator and the measurement signal acquisition unit 5 are connected to each other by an optical fiber.

The measurement light from the optical circulator is guided to the condenser lens by an optical fiber, and the measurement light condensed by the condenser lens is emitted into a space toward the measurement object 8 via an optical fiber from an end surface of the connector located at an end of the optical fiber.

The reflected light obtained by the measurement object 8 reflecting the measurement light is incident on the end surface of the connector, and is output to the measurement signal acquisition unit 5 as measurement reflected light by the optical circulator via an optical fiber.

The measurement object 8 is desirably near a focal point of the condenser lens in order to sufficiently obtain a light intensity of the reflected light from the measurement object 8.

Spatial scanning may be performed with light using a galvanometer mirror or the like.

Through the circulating light path 4, the reference output light from the light dividing unit 2 circulates N times (an integer equal to or more than 0), and the circulating light path 4 outputs circulating reference light for each circulation.

The circulating light path 4 includes a coupler 41 and a loop portion 42 made of an optical fiber.

The coupler 41 is an optical fiber coupler having two input ports and two output ports.

The reference output light from the light dividing unit 2, which is input to one input port of the coupler 41, is branched into two output ports. Circulating reference light that has circulated 0 times is output from one output port, and circulating light to the loop portion 42 is output from the other output port.

The circulating light to the loop portion 42, which is input to the other input port of the coupler 41, is branched into two output ports. Circulating reference light that has circulated N times is output from one output port, and circulating light to the loop portion 42 is output from the other output port.

That is, the coupler 41 outputs, from one output port, the circulating reference light obtained by causing the reference output light to pass as it is and the circulating reference light for each time the reference output light circulates through the loop portion 42 from once to N times to the measurement signal acquisition unit 5.

The loop portion 42 is an optical fiber that connects the other output port and the other input port of the coupler 41 to each other.

The optical fiber constituting the loop portion 42 is a single mode fiber.

The length of the optical fiber constituting the loop portion 42 is, for example, 1.0 m with respect to 0.5 m of the length of the reference light path from the wavelength sweeping light source 1 to the measurement signal acquisition unit 5 except for the loop portion.

Note that a dispersion shifted fiber may be used as the optical fiber constituting the loop portion 42. By using the dispersion shifted fiber, a slope of a frequency with respect to time can be increased for each number of circulations.

In addition, the optical fiber constituting the loop portion 42 may be covered with a heat insulating material. By covering the optical fiber constituting the loop portion 42 with a heat insulating material, an influence of a temperature change of the loop portion 42 can be further suppressed.

The measurement signal acquisition unit 5 combines the measurement reflected light from the irradiation optical system 3 and the circulating reference light from the circulating light path 4, and outputs an accurate measurement signal obtained by photoelectrically converting the combined interference light.

The signal processor unit 7 performs fast Fourier transform (FFT) on the accurate measurement signal, and performs accurate measurement to obtain a light path length difference between the measurement reflected light and the circulating reference light based on a peak position of a spectrum in the interference light of the measurement reflected light and the circulating reference light in a wavelength region of the sweep range of the swept light.

On the basis of the swept light, the measurement signal acquisition unit 5 outputs a plurality of rough measurement signals including electric signals obtained using a plurality of circulating number measurement light beams having different refractive index dependencies with respect to a light path.

The signal processor unit 7 performs fast Fourier transform (FFT) on the plurality of rough measurement signals, and performs rough measurement to determine the number of circulations in the loop portion 42 using a light path length difference between the plurality of circulating number measurement light beams based on a peak position of a spectrum in the plurality of circulating number measurement light beams.

The plurality of circulating number measurement light beams having different refractive index dependencies with respect to the reference light path which is a light path are light beams having a plurality of wavelength time dependencies based on the swept light.

Specifically, the plurality of circulating number measurement light beams are correction reference light beams having different wavelengths obtained by dividing the circulating reference light and correction reflected light beams having different wavelengths obtained by dividing the measurement reflected light, by a measurement position correction signal obtained by converting light divided into a plurality of different wavelengths within the sweep range of the swept light into an electric signal.

Each of the plurality of rough measurement signals is a signal obtained by combining the correction reference light and the correction reflected light having a corresponding wavelength and photoelectrically converting the combined interference light.

In the first embodiment, as an example, when swept light having a center wavelength of 1550 nm and a sweep range of 100 nm is used, two light beams of light in a first wavelength region in a band of 1500 nm to 1550 nm and light in a second wavelength region in a band of 1550 nm to 1600 nm are used as each of the correction reference light and the correction reflected light.

Note that the light in the first wavelength region and the light in the second wavelength region are separated from each other with a center wavelength of 1550 nm as a center. However, for example, the light in the first wavelength region may be light in 1500 nm to 1560 nm, the light in the second wavelength region may be light in 1540 nm to 1600 nm, and the light in the first wavelength region and the light in the second wavelength region may light in partially overlapped wavelength regions. The light in the first wavelength region may be light in 1500 nm to 1540 nm, the light in the second wavelength region may be light in 1560 nm to 1600 nm, and the light in the first wavelength region and the light in the second wavelength region may be light in separated wavelength regions.

In addition, light in 20 types of wavelength regions each having a band shifted by 5 nm from light in a sweep range of 1500 nm to 1600 nm may be used.

When the wavelength sweeping light source 1 that emits swept light having a center wavelength of 1550 nm and a sweep range of 100 nm having a wide sweep band is used, light in two wavelength regions of light in the first wavelength region and light in the second wavelength region based on the swept light only need to be divided into light in two wavelength regions of light in the first wavelength region and light in the second wavelength region by the measurement signal acquisition unit 5.

When the wavelength sweeping light source 1 that sweeps swept light in different wavelength regions with 1550 nm as a center, for example, 20 swept light beams each having a wavelength shifted by 5 nm in a time-multiplexed manner and emits swept light having a center wavelength of substantially 1550 nm and a sweep range of 100 nm is used, it is only required to use light in different wavelength regions divided into two of light in the first wavelength region and light in the second wavelength region at an emission stage from the wavelength sweeping light source 1.

In the first embodiment, the plurality of rough measurement signals are a first rough measurement signal obtained by combining the correction reference light in the first wavelength region and the correction reflected light in the first wavelength region and photoelectrically converting the combined interference light, and a second rough measurement signal obtained by combining the correction reference light in the second wavelength region and the correction reflected light in the second wavelength region and photoelectrically converting the combined interference light.

When the wavelength sweeping light source 1 that continuously changes a wavelength within a sweep range with respect to time and outputs swept light that is wavelength-swept laser light is used, the measurement signal acquisition unit 5 includes a combining unit, a photoelectric conversion unit, and the measurement position correction signal generator unit 6.

The combining unit combines the measurement reflected light from the irradiation optical system 3 and the circulating reference light from the circulating light path 4, and outputs the combined light, that is, interference light. The combining unit is a generally known one that obtains interference light by combining two light beams.

The photoelectric conversion unit converts the interference light from the combining unit into an electric signal and outputs a measurement signal.

Note that, as the optical fiber used in a measurement light path from the light dividing unit 2 to the photoelectric conversion unit of the measurement signal acquisition unit 5, it is preferable to use a polarization maintaining fiber that maintains two orthogonal polarization states. By using the polarization maintaining fiber, an influence on retardation caused by a cause other than the inside of the measurement object 8 is made less likely to occur, and measurement can be performed under a condition where a retardation fluctuation in an air layer from the irradiation optical system 3 to the measurement object 8 is small.

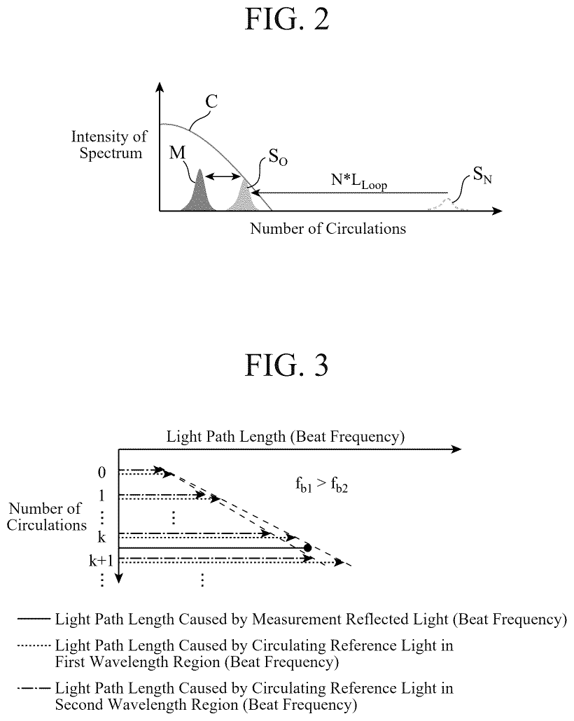

FIG. 2 illustrates a spectrum M caused by measurement reflected light indicated by a dark black mountain, and spectra S₀ to S_{N} caused by end surface reflected light that is reflected by an end surface from which measurement light is emitted in the connector of the irradiation optical system 3, which is so-called Fresnel reflection, indicated by light black mountains. In FIG. 2, C represents a coherence length.

The spectrum M caused by measurement reflected light is a spectrum obtained by the signal processor unit 7 performing fast Fourier transform on a measurement signal obtained by converting a beat frequency of measurement reflected light obtained by the combining unit of the measurement signal acquisition unit 5 into an electric signal.

In addition, the spectra S₀ to S_{N} caused by end surface reflected light are spectra obtained by the signal processor unit 7 performing fast Fourier transform on a measurement signal obtained by converting a beat frequency of measurement reflected light obtained by the combining unit of the measurement signal acquisition unit 5 into an electric signal.

By performing fast Fourier transform on an electric signal caused by interference light from the measurement signal acquisition unit 5, a frequency corresponding to a reflection position is obtained, and a peak is stronger as a reflected light intensity is stronger.

When the coherence length is short, as a path of the reference light path is longer, that is, as the number of circulations of the loop portion 42 increases, a peak of each of the beat frequencies S₀ to S_{N} caused by end surface reflected light is lower.

FIG. 3 illustrates a light path length (beat frequency) caused by measurement reflected light, a light path length (beat frequency) by circulating reference light in the first wavelength region (band of 1500 nm to 1550 nm), and a light path length (beat frequency) caused by circulating reference light in the second wavelength region (band of 1550 nm to 1600 nm), caused by the combining unit of the measurement signal acquisition unit 5.

The light path length caused by the circulating reference light in the first wavelength region corresponds to a light path length caused by first circulating number measurement light, and the light path length caused by the circulating reference light in the second wavelength region corresponds to a light path length caused by second circulating number measurement light.

In FIG. 3, the vertical axis represents the number of circulations of the circulating light path, the horizontal axis represents a light path length (beat frequency), the solid line represents a light path length caused by measurement reflected light, the broken line represents a light path length caused by circulating reference light in the first wavelength region, and the one-dot chain line represents a light path length caused by circulating reference light in the second wavelength region.

In addition, FIG. 3 illustrates that measurement reflected light is received between the k-th circulation and the (k+1)-th circulation, and FIG. 3 is a diagram illustrating a case where a beat frequency f_{b1} caused by the k-th circulating reference light and measurement reflected light is larger than a beat frequency f_{b2} caused by the (k+1)-th circulating reference light and measurement reflected light.

As illustrated in FIG. 3, the light path length is proportional to a refractive index at a wavelength in a refractive index of a light propagation medium, and therefore the light path length caused by the circulating reference light in the first wavelength region is shorter than the light path length caused by the circulating reference light in the second wavelength region, propagating through the same reference light path.

In a general single mode fiber, a slope of refractive index/wavelength is about-0.001/100 nm. For example, a light path length measured at a wavelength of 1500 nm is different from a light path length measured at a wavelength of 1600 nm, and the longer the wavelength, the shorter the light path length. Assuming that the loop length of the loop portion 42 is 1 m, when the wavelength is increased from 1500 nm to 1600 nm, 1000 μm as a decreased difference in the light path length is shifted in a negative direction.

In addition, a light path length caused by the circulating reference light in the first wavelength region and a light path length caused by the circulating reference light in the second wavelength region become longer every time the circulating reference light circulates through the loop portion 42 once, and a slope of the light path length caused by the circulating reference light in the first wavelength region with respect to the number of circulations is larger than a slope of the light path length caused by the circulating reference light in the second wavelength region with respect to the number of circulations.

Therefore, a difference between the light path length caused by the circulating reference light in the first wavelength region and the light path length caused by the circulating reference light in the second wavelength region for each circulation, that is, a shift amount is proportional to the number of circulations.

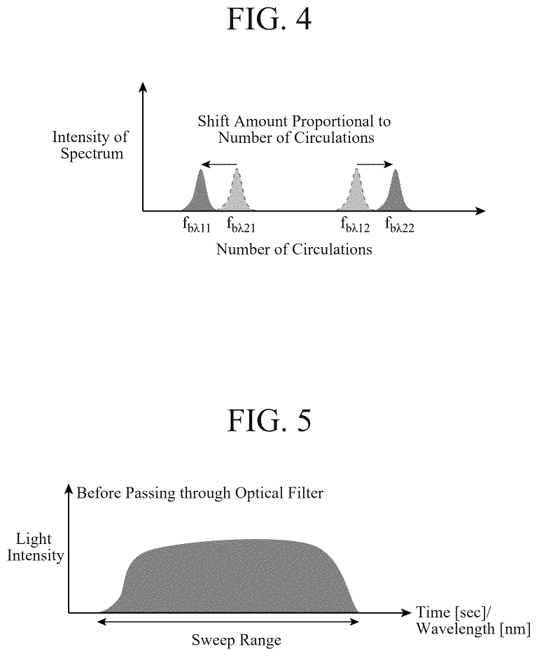

FIG. 4 illustrates a spectrum obtained by the signal processor unit 7 performing fast Fourier transform on a measurement signal obtained by converting a beat frequency obtained by the combining unit of the measurement signal acquisition unit 5 into an electric signal for each of the circulating reference light in the first wavelength region and the circulating reference light in the second wavelength region.

In FIG. 4, a spectrum f_{b1} caused by the circulating reference light in the first wavelength region is indicated by a dark black mountain, a spectrum f_{bλ2} caused by the circulating reference light in the second wavelength region is indicated by a light black mountain, and FIG. 4 is a diagram of a case where a beat frequency f_{b1} is larger than a beat frequency f_{b2}.

In FIG. 4, the horizontal axis represents the number of circulations, that is, a measured distance, and the vertical axis represents an intensity of a spectrum.

In FIG. 4, a spectrum f_{bλ11} and a spectrum f_{bλ21} located on the left side in the drawing indicate spectra in a case where the number of circulations is zero, and an interval between a peak position of the spectrum f_{bλ11} and a peak position of the spectrum f_{bλ21} indicates a shift amount, in other words, a difference in light path length difference in a case where the number of circulations is zero.

In addition, a spectrum f_{bλ12} and a spectrum f_{bλ22} located on the right side in FIG. 4 indicate spectra in a case where the number of circulations is N, and an interval between a peak position of the spectrum f_{bλ12} and a peak position of the spectrum f_{bλ22} indicates a shift amount, in other words, a difference in light path length difference in a case where the number of circulations is N.

Therefore, since the shift amount is proportional to the number of circulations, a timing at which measurement reflected light is received, in other words, the number of circulations can be determined by obtaining the shift amount.

The optical measurement device according to the first embodiment performs rough measurement of determining the number of circulations of the loop portion 42 using a difference between a light path length caused by the circulating reference light in the first wavelength region and a light path length caused by the circulating reference light in the second wavelength region by utilizing the fact that a wavelength dispersion characteristic of the measurement light path and a wavelength dispersion characteristic of the reference light path are different due to presence of a space between an end surface of the connector of the irradiation optical system 3 and the measurement object 8 in the measurement light path.

The measurement position correction signal generator unit 6 (hereinafter, abbreviated as a correction signal generator unit) generates a measurement position correction signal (hereinafter, abbreviated as a correction signal) used to cut out a plurality of wavelengths at the time of rough measurement for each cycle on the basis of the swept light of each cycle.

In this example, the correction signal generator unit 6 generates a correction signal for cutting out each of the first wavelength region and the second wavelength region from the circulating reference light and the measurement reflected light.

The swept light emitted from the wavelength sweeping light source 1 includes a linear fluctuation (jitter) in a time axis direction, that is, with respect to time, for every cycle, that is, every sweep.

The correction signal is a signal for accurately cutting out a plurality of wavelengths even when the swept light fluctuates due to a jitter.

The correction signal generator unit 6 includes an optical filter 61 and an optical detector 62.

The optical filter 61 receives, as an input, a part of the swept light emitted from the wavelength sweeping light source 1 via the light dividing unit 2, and cuts out position correction light in the first wavelength region and position correction light in the second wavelength region.

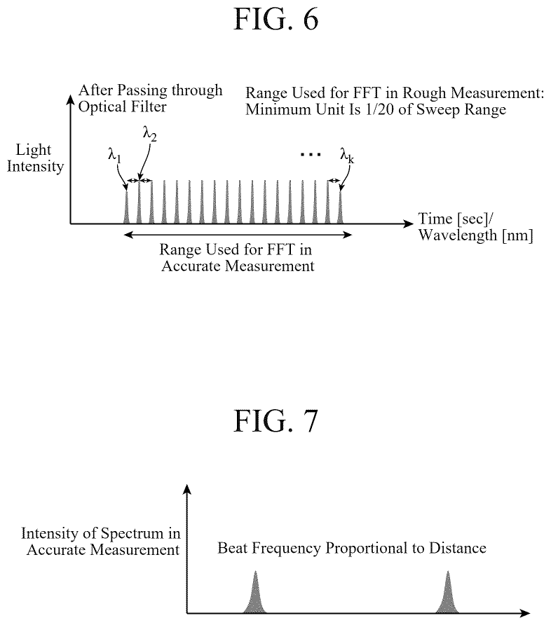

The optical filter 61 receives, as an input, a part of the swept light having a center wavelength of 1550 nm and a sweep range of 100 nm illustrated in FIG. 6, and cuts out position correction light in the first wavelength region in a band of 1500 nm to 1500 nm and position correction light in the second wavelength region in a band of 1550 nm to 1600 nm.

Note that, as illustrated in FIG. 6, the position correction light only needs to be k position correction light beams consisting of λ₁ to λ_{K} beams obtained by dividing the sweep range of the swept light into 1/k (k is an integer equal to or more than 2).

For example, when k is 20, the optical filter 61 may cut out position correction light beams in the first wavelength region λ₁ to the twentieth wavelength region λ₂₀ in which a bandwidth is 5 nm in a band of 1500 nm to 1600 nm.

By increasing the number of position correction light beams, accuracy of determining the number of circulations is enhanced.

The optical filter 61 uses a gas cell that is a member that transmits only a specific wavelength.

As the optical filter 61, a member that can obtain an absorption spectrum corresponding to a molecular vibration mode, such as a hydrogen cyanide (HCN) gas cell, or a member that transmits only a specific wavelength using a Mach-Zehnder (MZ) interferometer, such as an etalon, may be used.

The photodetector (PD) 62 converts the position correction light in the first wavelength region and the position correction light in the second wavelength region from the optical filter 61 into electric signals, and outputs a first correction signal and a second correction signal to the measurement signal acquisition unit 5.

Note that, when 20 position correction light beams are cut out by the optical filter 61, the position correction light beams are converted into electric signals, and the first through twentieth correction signals are output to the measurement signal acquisition unit 5.

The correction signal generator unit 6 obtains the correction signal using a part of the swept light emitted from the wavelength sweeping light source 1 and input via the light dividing unit 2. However, it is only required to obtain a sweep characteristic of the wavelength sweeping light source as the correction signal, and therefore the correction signal generator unit 6 may obtain the correction signal using circulating reference light circulating zero times (not circulating) as the reference output light from the circulating light path 4.

The measurement signal acquisition unit 5 performs synchronization with the swept light emitted from the wavelength sweeping light source 1 by the first correction signal and the second correction signal from the correction signal generator unit 6, cuts out correction reference light in the first wavelength region and correction reference light in the second wavelength region from the circulating reference light from the circulating light path 4 as circulating number measurement light, and cuts out correction reflected light in the first wavelength region and correction reflected light in the second wavelength region from the measurement reflected light from the irradiation optical system 3.

The measurement signal acquisition unit 5 outputs a first rough measurement signal obtained by combining the correction reference light in the first wavelength region and the correction reflected light in the first wavelength region and photoelectrically converting the combined interference light, and a second rough measurement signal obtained by combining the correction reference light in the second wavelength region and the correction reflected light in the second wavelength region and photoelectrically converting the combined interference light to the signal processor unit 7.

Note that, in a case where the wavelength sweeping light source 1 sweeps 20 swept light beams each having a wavelength shifted by 5 nm from 1550 nm as a center in a time-multiplexed manner, and emits swept light having a center wavelength of substantially 1550 nm and a sweep range of 100 nm having a wide sweep band and in a case where an accurate measurement signal is obtained, light having a center wavelength of substantially 1550 nm and a sweep range of 100 nm having a wide sweep band is used as the measurement reflected light from the irradiation optical system 3 and the circulating reference light from the circulating light path 4.

In a case where rough measurement signals in the first wavelength region and the second wavelength region are obtained, it is only required to use ten measurement reflected light beams from the irradiation optical system 3 and ten circulating reference light beams from the circulating light path 4, the measurement reflected light beams and the circulating reference light beams being obtained by dividing the wavelengths of the 20 swept light beams into two parts including an upper part and a lower part.

At this time, the swept light in the first wavelength region output from the wavelength sweeping light source 1 is synchronized with the correction reference light in the first wavelength region and the correction reflected light in the first wavelength region input to the measurement signal acquisition unit 5, and the swept light in the second wavelength region output from the wavelength sweeping light source 1 is synchronized with the correction reference light in the second wavelength region and the correction reflected light in the second wavelength region input to the measurement signal acquisition unit 5.

In this case, the correction signal generator unit 6 is not required.

The signal processor unit 7 performs fast Fourier transform on an accurate measurement signal including an electric signal obtained by combining the measurement reflected light from the irradiation optical system 3 and the circulating reference light from the circulating light path 4 in the same band as the band of the sweep range of the swept light emitted from the wavelength sweeping light source 1 in the measurement signal acquisition unit 5, and performs accurate measurement to obtain a light path length difference between the measurement reflected light and the circulating reference light based on a peak position of a spectrum in interference light between the measurement reflected light and the circulating reference light in the wavelength region of the sweep range of the swept light.

In the accurate measurement, the signal processor unit 7 obtains a beat frequency using the measurement reflected light and the circulating reference light in a wide wavelength range in the same band as the sweep range of the swept light. Therefore, a full width at half maximum of the beat frequency is inversely proportional to the wavelength range used for the fast Fourier transform, but the accurate measurement with high accuracy can be performed.

For example, in a case where the center wavelength is 1550 nm and the sweep range is 100 nm, the full width at half maximum of an obtained beat frequency is about 10 μm, and therefore distance measurement with sufficiently high accuracy of about 1 μm can be performed.

A spectrum obtained as a result of the accurate measurement by the signal processor unit 7 is illustrated in FIG. 7. In FIG. 7, when the number of circulations of the measurement reflected light illustrated in FIG. 3 is k times or (k+1) times, a spectrum located on the left side indicates that the measurement reflected light is located on the k-th circulating reference light side, and a spectrum located on the right side indicates that the measurement reflected light is located on the (k+1)-th circulating reference light side.

That is, it is possible to measure a light path length difference between the measurement reflected light and the circulating reference light, that is, a distance, based on a peak position of a spectrum in the interference light between the wavelength region measurement reflected light and the circulating reference light in the sweep range of the swept light.

Note that the number of circulations k of the circulating reference light cannot be determined only by the accurate measurement.

For example, it is assumed that the length of the reference light path from the wavelength sweeping light source 1 to the measurement signal acquisition unit 5 except for the loop portion 42 is 0.5 m, the length of a loop of the loop portion 42 is 1.0 m, and a measurement light path passing through the measurement object 8 is 1.8 m.

A result obtained by the accurate measurement by the signal processor unit 7 is 0.3 m (=1.8−1.5), which is a difference in the light path length between the measurement reflected light and the circulating reference light.

The signal processor unit 7 performs fast Fourier transform on the first rough measurement signal synchronized with the swept light emitted from the wavelength sweeping light source 1 by the first correction signal from the correction signal generator unit 6 in the measurement signal acquisition unit 5, and obtains a light path length difference in the first wavelength region based on a peak position of a spectrum in the interference light caused by the correction reference light in the first wavelength region.

The signal processor unit 7 performs fast Fourier transform on the second rough measurement signal synchronized with the swept light emitted from the wavelength sweeping light source 1 by the second correction signal from the correction signal generator unit 6 in the measurement signal acquisition unit 5, and obtains a light path length difference in the second wavelength region based on a peak position of a spectrum in the interference light caused by the correction reference light in the second wavelength region.

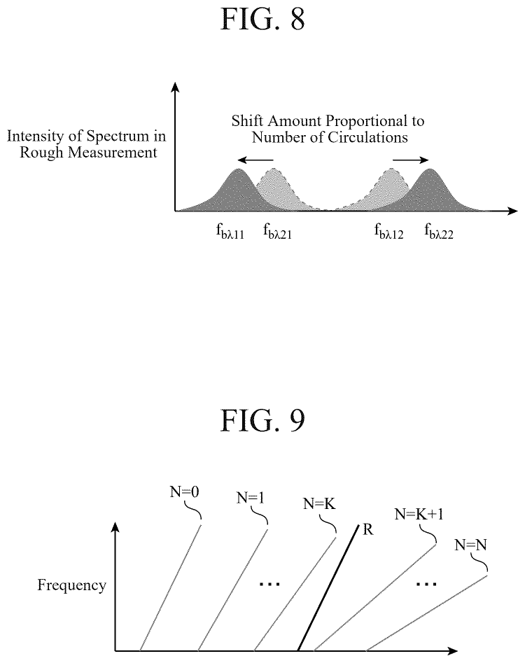

FIG. 8 illustrates a spectrum obtained by performing fast Fourier transform on the first rough measurement signal and the second rough measurement signal by the signal processor unit 7.

As illustrated in FIG. 8, a shift amount, which is a peak interval between a spectrum caused by a light path length difference in the first wavelength region and a spectrum caused by a light path length difference in the second wavelength region, is proportional to the number of circulations.

Therefore, in advance, a relationship between the number of circulations and the shift amount is stored in a table, or a linear relationship between the number of circulations and the shift amount is stored.

Note that, when a slope of a wavelength with respect to the temperature of a light propagation medium in the reference light path is not linear, an influence of a temperature change is considered in the table or the linear relationship.

FIG. 8 is a diagram similar to FIG. 4, and in FIG. 8, a spectrum f_{bλ11} caused by a light path length difference in the first wavelength region and a spectrum f_{bλ21} caused by a light path length difference in the second wavelength region located on the left side in the drawing indicate spectra in a case where the number of circulations is zero, and an interval between a peak position of the spectrum f_{bλ11} and a peak position of the spectrum f_{bλ21} indicates a shift amount, in other words, a difference in light path length difference in a case where the number of circulations is zero.

In addition, a spectrum f_{bλ12} and a spectrum f_{bλ22} located on the right side in FIG. 8 indicate spectra in a case where the number of circulations is N, and an interval between a peak position of the spectrum f_{bλ12} and a peak position of the spectrum f_{bλ22} indicates a shift amount, in other words, a difference in light path length difference in a case where the number of circulations is N.

When the first rough measurement signal is a rough measurement signal including an electric signal obtained by combining the measurement reflected light (correction reflected light) from the irradiation optical system 3 and the circulating reference light (correction reference light) from the circulating light path 4 in the first wavelength region, and the second rough measurement signal is a rough measurement signal including an electric signal obtained by combining the measurement reflected light (correction reflected light) from the irradiation optical system 3 and the circulating reference light (correction reference light) from the circulating light path 4 in the second wavelength region, a light path length difference in the first wavelength region between the correction reflected light and the correction reference light in the first wavelength region and a light path length difference in the second wavelength region between the correction reflected light and the correction reference light in the second wavelength region are obtained.

A shift amount between the light path length difference in the first wavelength region and the light path length difference in the second wavelength region is obtained, and the number of circulations with respect to the obtained shift amount is obtained from the obtained shift amount, and the relationship between the number of circulations and the shift amount stored as a table or the stored linear relationship between the number of circulations and the shift amount.

The signal processor unit 7 performs rough measurement using the first rough measurement signal and the second rough measurement signal from the measurement signal acquisition unit 5, and obtains the number of circulations by which the measurement reflected light from the irradiation optical system 3 is obtained.

For example, similarly to the above example, it is assumed that the length of the reference light path from the wavelength sweeping light source 1 to the measurement signal acquisition unit 5 except for the loop portion 42 is 0.5 m, the length of a loop of the loop portion 42 is 1.0 m, and a measurement light path passing through the measurement object 8 is 1.8 m.

In the rough measurement by the signal processor unit 7, from the shift amount between the light path length difference in the first wavelength region and the light path length difference in the second wavelength region and the relationship between the number of circulations and the shift amount in the table, it is determined that the number of circulations is located between the number of circulations 1 (light path length of circulating reference light: 1.5 m) and the number of circulations 2 (light path length of circulating reference light: 2.5 m) and on a side of the number of circulations 1.

As a result, distance measurement of 1.8 m which is a sum of 0.3 m obtained by the accurate measurement and 1.5 m at the number of circulations 1 obtained by the rough measurement can be performed.

The signal processor unit 7 increase a speed by performing parallel processing on the fast Fourier transform of the accurate measurement signal in the accurate measurement and the fast Fourier transform of each of the first rough measurement signal and the second rough measurement signal in the rough measurement.

As illustrated in FIG. 9, the optical measurement device according to the first embodiment can identify the number of circulations by rough measurement because a slope of a frequency of the circulating reference light with respect to time changes due to wavelength dispersion for each circulation of the loop in the loop portion 42 by utilizing the fact that a wavelength dispersion characteristic of the measurement light path and a wavelength dispersion characteristic of the reference light path are different due to presence of a space between an end surface of the connector of the irradiation optical system 3 and the measurement object 8 in the measurement light path.

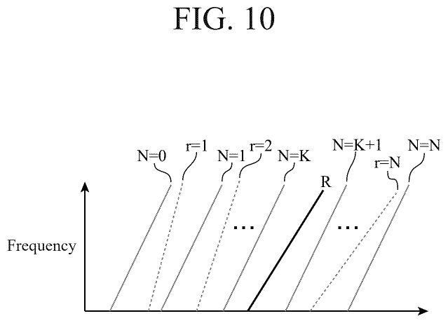

Note that by using an optical fiber different from a single mode fiber used for another path, for example, a dispersion shifted fiber, as the optical fiber constituting the loop portion 42, the slope with respect to the number of circulations may be increased, and the accuracy of identifying the number of circulations may be further improved. In addition, as illustrated in FIG. 10, the number of circulations may be identified by rough measurement because a slope of a frequency of the measurement reflected light with respect to time changes due to wavelength dispersion for each circulation of the loop in the loop portion 42 by utilizing the fact that the thickness of an air layer between the measurement object 8 and an end surface of the connector of the irradiation optical system 3 is proportional to a distance to the measurement object 8.

Next, operations of the accurate measurement and the rough measurement in the optical measurement device according to the first embodiment will be described.

First, the operation of the accurate measurement will be described.

When the measurement reflected light is input to the measurement signal acquisition unit 5, the measurement signal acquisition unit 5 combines the input measurement reflected light and circulating reference light before and after a time point at which the measurement reflected light is input, and outputs an accurate measurement signal converted into an electric signal to the signal processor unit 7.

The signal processor unit 7 performs fast Fourier transform on the accurate measurement signal, obtains a light path length difference between the measurement reflected light and the circulating reference light based on a peak position of a spectrum in the interference light between the measurement reflected light and the circulating reference light in a wavelength region of the sweep range of the swept light, and obtains a distance obtained by the measurement reflected light and the circulating reference light.

Meanwhile, in the rough measurement, when the measurement reflected light is input to the measurement signal acquisition unit 5, the measurement signal acquisition unit 5 combines the correction reflected light that is the measurement reflected light in the first wavelength region in the input measurement reflected light, synchronized with the first wavelength region of the swept light emitted from the wavelength sweeping light source 1 by the first correction signal from the correction signal generator unit 6 and the correction reference light that is the circulating reference light in the first wavelength region in the circulating reference light before and after a time point at which the measurement reflected light is input, and outputs the first rough measurement signal converted into an electric signal to the signal processor unit 7.

In addition, the measurement signal acquisition unit 5 combines the correction reflected light that is the measurement reflected light in the second wavelength region in the input measurement reflected light, synchronized with the second wavelength region of the swept light emitted from the wavelength sweeping light source 1 by the second correction signal from the correction signal generator unit 6 and the correction reference light that is the circulating reference light in the second wavelength region in the circulating reference light before and after a time point at which the measurement reflected light is input, and outputs the second rough measurement signal converted into an electric signal to the signal processor unit 7.

Note that, when the wavelength sweeping light source 1 that outputs each of swept light beams having been wavelength-swept to the first wavelength region and the second wavelength region having different wavelength regions in a time-multiplexed manner by the sweeping unit within the sweep range is used, the measurement signal acquisition unit 5 combines each of the correction reflected light beams that are input measurement reflected light beams in the first wavelength region and the second wavelength region, synchronized with swept light beams in the first wavelength region and the second wavelength region emitted from the wavelength sweeping light source 1, respectively, and each of the correction reference light beams that are circulating reference light beams in the first wavelength region and the second wavelength region before and after a time point at which the measurement reflected light beams in the first wavelength region and the second wavelength region are input, and outputs the first wavelength region and the second rough measurement signal converted into electric signals to the signal processor unit 7.

The correction reflected light and the correction reference light constitute the circulating number measurement light.

The signal processor unit 7 performs fast Fourier transform on the first rough measurement signal, obtains a light path length difference in the first wavelength region between the measurement reflected light and the circulating reference light in the first wavelength region based on a peak position of a spectrum in the interference light caused by the circulating reference light in the first wavelength region, performs fast Fourier transform on the second rough measurement signal, and obtains a light path length difference in the second wavelength region between the measurement reflected light and the circulating reference light in the second wavelength region based on a peak position of a spectrum in the interference light caused by the circulating reference light in the second wavelength region.

The signal processor unit 7 obtains a shift amount between the light path length difference in the first wavelength region and the light path length difference in the second wavelength region, and obtains the number of circulations with respect to the obtained shift amount from the obtained shift amount, and the relationship between the number of circulations and the shift amount stored as a table or the stored linear relationship between the number of circulations and the shift amount.

The signal processor unit 7 obtains a distance to the measurement object 8 from the distance obtained by the measurement reflected light and the circulating reference light, obtained by the accurate measurement, and the number of circulations obtained by the rough measurement, and outputs the obtained distance.

As described above, in the accurate measurement, by using the measurement reflected light and the circulating reference light in the same band as the wide sweep range from the wavelength sweeping light source 1 and using all the wide bands for fast Fourier transform, there is no fluctuation in a peak position as illustrated in FIG. 7, and high accuracy can be maintained in the distance measurement.

In the rough measurement, by performing fast Fourier transform using the measurement reflected light and the circulating reference light in a band narrower than the sweep range, as illustrated in FIG. 8, shift amount information can be accurately obtained although a spectrum width is widened.

Since the optical measurement device according to the first embodiment includes the circulating light path having the loop portion, a measurement range can be expanded even when a low coherence light source having a narrow measurement range is used as the wavelength sweeping light source 1.

In addition, the measurement signal acquisition unit 5 that outputs, on the basis of the swept light, a plurality of rough measurement signals including electric signals obtained using a plurality of circulating number measurement light beams having different refractive index dependencies with respect to a light path, and the signal processor unit 7 that identifies the number of circulations of the circulating reference light in the circulating light path 4, in which the light path length difference between the measurement reflected light and the circulating reference light is obtained from the plurality of rough measurement signals from the measurement signal acquisition unit 5, are included, and therefore, measurement is hardly affected by a change in environmental temperature, and a distance to a measurement object can be measured with high accuracy.

In addition, the optical measurement device according to the first embodiment obtains a plurality of rough measurement signals for identifying the number of circulations by the measurement reflected light and the circulating reference light in wavelength regions corresponding to wavelength regions obtained by dividing the sweep range of the swept light from the wavelength sweeping light source 1 into a plurality of parts, and therefore does not increase deterioration of time resolution of measurement and complexity of a hardware configuration as the optical measurement device.

### Second Embodiment

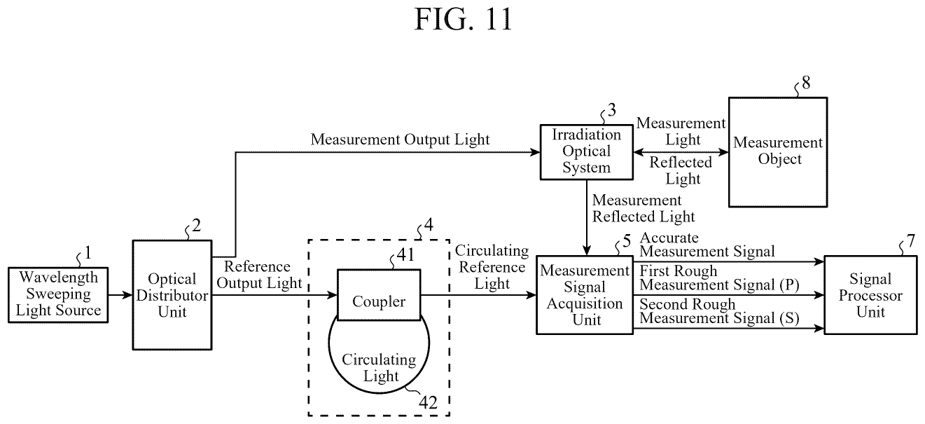

An optical measurement device according to a second embodiment will be described with reference to FIGS. 11 to 14.

The optical measurement device according to the second embodiment is different from the optical measurement device according to the first embodiment in that the optical measurement device according to the second embodiment obtains a first rough measurement signal and a second rough measurement signal by correction reflected light and correction reference light obtained by separating each of measurement reflected light and circulating reference light into two polarized light beams orthogonal to each other, whereas the optical measurement device according to the first embodiment obtains the first circulating number measurement light and the second circulating number measurement light, having different refractive index dependencies with respect to a light path, for obtaining the first rough measurement signal and the second rough measurement signal, by measurement reflected light and circulating reference light in wavelength regions corresponding to wavelength regions obtained by dividing the sweep range of the swept light from the wavelength sweeping light source 1 into a plurality of parts, and the other points are the same or similar.

In FIGS. 11 to 14, the same reference numerals as in FIGS. 1 to 10 denote the same or corresponding portions.

The optical measurement device according to the second embodiment obtains a first rough measurement signal and a second rough measurement signal by utilizing a polarization dependency of a refractive index of a light propagation medium on two polarized light beams, that is, light in a polarization mode P and light in a polarization mode S orthogonal to the polarization mode P, so-called birefringence, and identifies the number of circulations of a circulating light path.

The optical measurement device according to the second embodiment obtains a first rough measurement signal and a second rough measurement signal by utilizing a fact that a difference between a beat frequency (light path length) of light in a polarization mode P and a beat frequency (light path length) of light in a polarization mode S, a so-called shift amount, is proportional to the number of circulations of a circulating light path and birefringence, and identifies the number of circulations of the circulating light path in reference output light using the obtained first rough measurement signal and second rough measurement signal.

Note that the light path length is proportional to a product of the length of a light propagation medium and a refractive index, the beat frequency is proportional to the light path length, and a difference between light path lengths having different types of birefringence is proportional to the number of circulations of the circulating light path.

As illustrated in FIG. 11, the optical measurement device according to the second embodiment includes a wavelength sweeping light source 1, a light dividing unit 2, an irradiation optical system 3, a circulating light path 4, a measurement signal acquisition unit 5, and a signal processor unit 7.

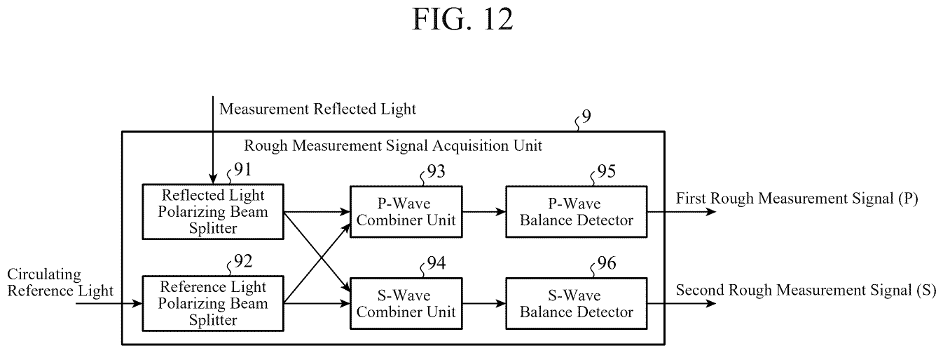

The measurement signal acquisition unit 5 includes a rough measurement signal acquisition unit 9 illustrated in FIG. 12.

Hereinafter, the optical measurement device according to the second embodiment will be described focusing on the measurement signal acquisition unit 5 in the optical measurement device according to the first embodiment, particularly the rough measurement signal acquisition unit 9.

Description of the wavelength sweeping light source 1, the light dividing unit 2, the irradiation optical system 3, and the circulating light path 4 having the same configurations as those of the optical measurement device according to the first embodiment will be omitted as much as possible.

Note that it is preferable to use a polarization maintaining optical fiber as an optical fiber used for a measurement light path and a reference light path. By using the polarization maintaining optical fiber, birefringence is temporally and spatially stabilized over the entire length of the polarization maintaining optical fiber.

The measurement signal acquisition unit 5 combines the measurement reflected light from the irradiation optical system 3 and the circulating reference light from the circulating light path 4, and outputs an accurate measurement signal obtained by photoelectrically converting the combined interference light.

As illustrated in FIG. 12, the rough measurement signal acquisition unit 9 includes a reflected light polarizing beam splitter 91, a reference light polarizing beam splitter 92, a P-wave combining unit 93, an S-wave combining unit 94, a P-wave balance detector 95, and an S-wave balance detector 96.

The measurement signal acquisition unit 5 uses an integrated coherent receiver (ICR) which is an optical integrated device generally used for a receiver in the field of optical information communication.

The reflected light polarizing beam splitter 91 divides measurement reflected light from the irradiation optical system 3 into P-wave correction reflected light that is measurement reflected light in a polarization mode P (hereinafter, referred to as a P wave) and S-wave correction reflected light that is measurement reflected light in a polarization mode S (hereinafter, referred to as an S wave).

The reference light polarizing beam splitter 92 divides circulating reference light from the circulating light path 4 into P-wave correction reference light that is P-wave circulating reference light and P-wave correction reference light that is S-wave circulating reference light.

The P-wave combining unit 93 combines the P-wave measurement reflected light from the reflected light polarizing beam splitter 91 and the P-wave circulating reference light from the reference light polarizing beam splitter 92, and outputs the combined light, that is, P-wave interference light having a beat frequency.

The S-wave combining unit 94 combines the S-wave measurement reflected light from the reflected light polarizing beam splitter 91 and the S-wave circulating reference light from the reference light polarizing beam splitter 92, and outputs the combined light, that is, S-wave interference light having a beat frequency.

The P-wave balance detector 95 converts the P-wave interference light from the P-wave combining unit 93 into an electric signal and outputs a first measurement signal (P wave).

The S-wave balance detector 96 converts the S-wave interference light from the S-wave combining unit 94 into an electric signal and outputs a second measurement signal (S-wave).

The P-wave balance detector 95 and the S-wave balance detector 96 are constituted by balanced photodiodes (BPD), and convert the P-wave interference light and the S-wave interference light into electric signals.

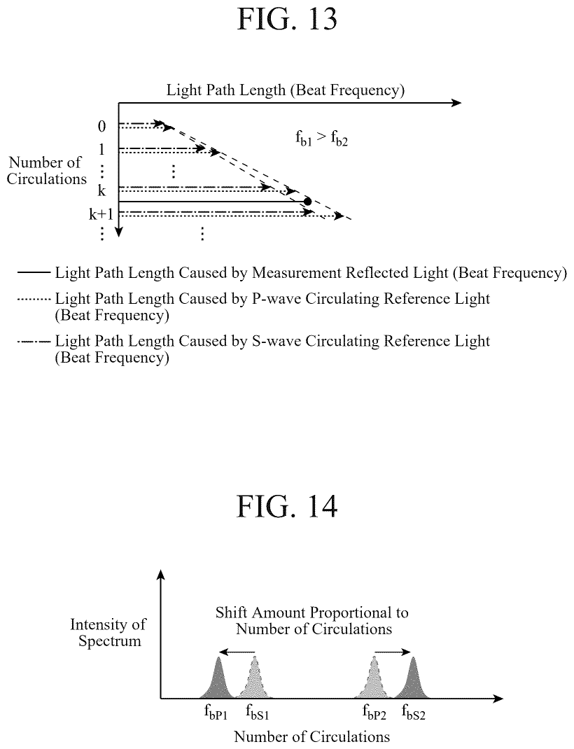

FIG. 13 illustrates a light path length (beat frequency) caused by the P-wave circulating reference light and a light path length (beat frequency) caused by the S-wave circulating reference light.

In FIG. 13, the vertical axis represents the number of circulations of the circulating light path, the horizontal axis represents a light path length (beat frequency), the solid line represents a light path length caused by measurement reflected light, the broken line represents a light path length caused by the P-wave circulating reference light, and the one-dot chain line represents a light path length caused by the S-wave circulating reference light.

In addition, FIG. 13 illustrates that measurement reflected light is received between the k-th circulation and the (k+1)-th circulation, and FIG. 13 is a diagram illustrating a case where a beat frequency f_{b1} of the k-th circulating reference light and measurement reflected light is larger than a beat frequency f_{b2} of the (k+1)-th circulating reference light and measurement reflected light.

The light path length caused by the P-wave circulating reference light is shorter than the light path length caused by the S-wave circulating reference light.

The light path length caused by the P-wave circulating reference light and the light path length caused by the S-wave circulating reference light become longer every time the circulating reference light circulates through the loop portion 42 once, and a slope of the light path length caused by the P-wave circulating reference light with respect to the number of circulations is larger than a slope of the light path length caused by the S-wave circulating reference light with respect to the number of circulations.

Therefore, a difference between the light path length caused by the P-wave circulating reference light and the light path length caused by the S-wave circulating reference light for each circulation, that is, a shift amount is proportional to the number of circulations.

FIG. 14 illustrates a spectrum obtained by the signal processor unit 7 performing fast Fourier transforming on each of a first (P wave) measurement signal and a second (S wave) measurement signal.

In FIG. 14, a spectrum for caused by the P-wave circulating reference light is indicated by a dark black mountain, a spectrum f_{bS} caused by the S-wave circulating reference light is indicated by a light black mountain, and FIG. 14 is a diagram of a case where a beat frequency f_{b1} is larger than a beat frequency f_{b2}.

In FIG. 14, the horizontal axis represents the number of circulations, that is, a measured distance, and the vertical axis represents an intensity of a spectrum.

In FIG. 14, a spectrum f_{bP1} and a spectrum f_{bS1} located on the left side in the drawing indicate spectra in a case where the number of circulations is zero, and an interval between a peak position of the spectrum f_{bP1} and a peak position of the spectrum f_{bS1} indicates a shift amount, in other words, a difference in light path length difference in a case where the number of circulations is zero.

In addition, a spectrum f_{bP2} and a spectrum f_{bS2} located on the right side in FIG. 14 indicate spectra in a case where the number of circulations is N, and an interval between a peak position of the spectrum f_{bP2} and a peak position of the spectrum f_{bS2} indicates a shift amount, in other words, a difference in light path length difference in a case where the number of circulations is N.

Therefore, since the shift amount is proportional to the number of circulations, a timing at which measurement reflected light is received, in other words, the number of circulations can be determined by obtaining the shift amount.

As is clear from FIGS. 13 and 14, since birefringence is determined by a light propagation medium in the measurement light path and the reference light path, and the shift amount is proportional to the number of circulations, a relationship between the shift amount and the number of circulations is acquired in advance, and the relationship between the number of circulations and the shift amount is stored in a table.

Next, operations of the accurate measurement and the rough measurement in the optical measurement device according to the second embodiment will be described.

First, the operation of the accurate measurement will be described.

When the measurement reflected light is input to the measurement signal acquisition unit 5, the measurement signal acquisition unit 5 combines the input measurement reflected light and circulating reference light before and after a time point at which the measurement reflected light is input, and outputs an accurate measurement signal converted into an electric signal to the signal processor unit 7.

The signal processor unit 7 performs fast Fourier transform on the accurate measurement signal, obtains a light path length difference between the measurement reflected light and the circulating reference light based on a peak position of a spectrum in the interference light of the measurement reflected light and the circulating reference light in a wavelength region of the sweep range of the swept light, and obtains a distance obtained by the measurement reflected light and the circulating reference light.

Meanwhile, in the rough measurement, when the measurement reflected light is input to the measurement signal acquisition unit 5, the rough measurement signal acquisition unit 9 in the measurement signal acquisition unit 5 combines P-wave measurement reflected light in the input measurement reflected light and P-wave circulating reference light in circulating reference light before and after a time point at which the measurement reflected light is input, and outputs a first rough measurement signal converted into an electric signal to the signal processor unit 7.

In addition, the measurement signal acquisition unit 5 combines S-wave measurement reflected light in the input measurement reflected light and S-wave circulating reference light in circulating reference light before and after a time point at which the measurement reflected light is input, and outputs a second rough measurement signal converted into an electric signal to the signal processor unit 7.

The signal processor unit 7 performs fast Fourier transform on the first rough measurement signal, obtains a P-wave light path length difference between the P-wave measurement reflected light and the P-wave circulating reference light based on a peak position of a spectrum in the interference light caused by the P-wave circulating reference light, performs fast Fourier transform on the second rough measurement signal, and obtains an S-wave light path length difference between the S-wave measurement reflected light and the S-wave circulating reference light based on a peak position of a spectrum in the interference light caused by the S-wave circulating reference light.

The signal processor unit 7 obtains a shift amount between the P-wave light path length difference and the S-wave light path length difference, and obtains the number of circulations with respect to the obtained shift amount from the obtained shift amount, and the relationship between the number of circulations and the shift amount stored as a table.

The signal processor unit 7 obtains a distance to the measurement object 8 from the distance obtained by the measurement reflected light and the circulating reference light, obtained by the accurate measurement, and the number of circulations obtained by the rough measurement, and outputs the obtained distance.

As described above, in the accurate measurement, by using the measurement reflected light and the circulating reference light in the same band as the wide sweep range from the wavelength sweeping light source 1 and using all the wide bands for fast Fourier transform, there is no fluctuation in a peak position, and high accuracy can be maintained in the distance measurement.

In the rough measurement, the first rough measurement signal caused by a P wave and the second rough measurement signal caused by an S wave are subjected to fast Fourier transform using the P-wave measurement reflected light, the P-wave circulating reference light, the S-wave measurement reflected light, and the S-wave circulating reference light, whereby information on the shift amount can be accurately obtained.

Since the optical measurement device according to the second embodiment includes the circulating light path having the loop portion, a measurement range can be expanded even when a low coherence light source having a narrow measurement range is used as the wavelength sweeping light source 1.

In addition, the measurement signal acquisition unit 5 that outputs the first rough measurement signal caused by a P wave and the second rough measurement signal caused by an S wave including electric signals by the P-wave circulating reference light and the S-wave circulating reference light, respectively, by utilizing a polarization dependency of a refractive index of a light propagation medium on two polarized light beams having different refractive index dependencies with respect to a light path, that is, light in a polarization mode P and light in a polarization mode S, so-called birefringence, and the signal processor unit 7 that identifies the number of circulations of the circulating reference light in the circulating light path 4, in which a light path length difference between the measurement reflected light and the circulating reference light is obtained from the P-wave rough measurement signal and the S-wave rough measurement signal from the measurement signal acquisition unit 5, are included, and therefore, measurement is hardly affected by a change in environmental temperature, and a distance to a measurement object can be measured with high accuracy.

In addition, the optical measurement device according to the second embodiment obtains the first rough measurement signal and the second rough measurement signal for identifying the number of circulations by a P wave and an S wave in each of the measurement reflected light and the circulating reference light difference, and therefore does not increase deterioration of time resolution of measurement and complexity of a hardware configuration as the optical measurement device.

### Third Embodiment

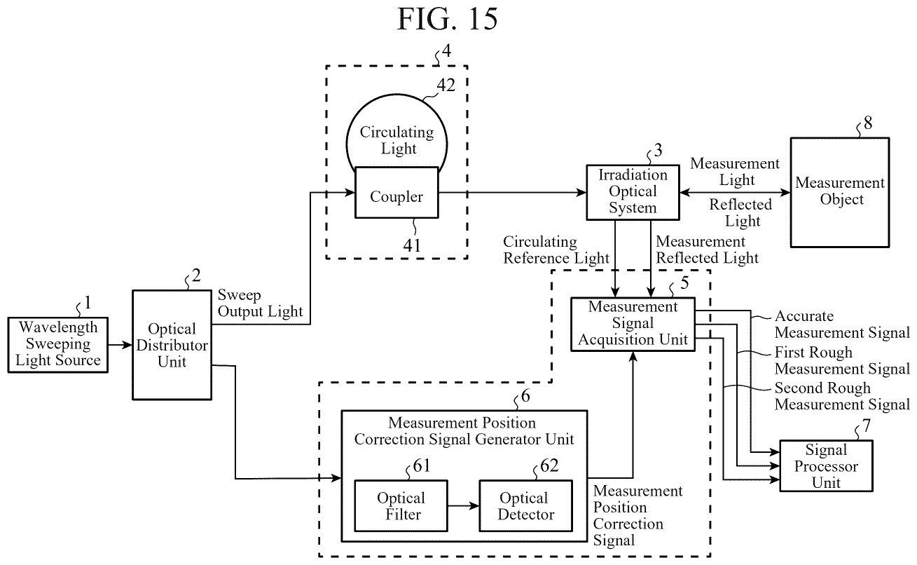

An optical measurement device according to a third embodiment will be described with reference to FIG. 15.

The optical measurement device according to the third embodiment is different from the optical measurement device according to the first embodiment in that the optical measurement device according to the third embodiment uses a common light path interference system, and the other points are the same or similar.

In FIG. 15, the same reference numerals as in FIGS. 1 to 10 denote the same or corresponding portions.

In the optical measurement device according to the first embodiment, an optical fiber used in a measurement light path in which measurement output light is emitted as measurement light from the light dividing unit 2 through the irradiation optical system 3 toward the measurement object 8, and the emitted measurement light is reflected by the measurement object 8, passes through the irradiation optical system 3, and reaches the measurement signal acquisition unit 5 as measurement reflected light is different from an optical fiber used in a reference light path in which reference output light travels as circulating reference light from the light dividing unit 2 to the measurement signal acquisition unit 5 through the circulating light path 4.

Meanwhile, in the optical measurement device according to the third embodiment, a common light path interference system is used, and a common optical fiber is used for a measurement light path and a reference light path.

Note that, in FIG. 15, the measurement reflected light and the circulating reference light are separately illustrated, but are separately illustrated for convenience of description, and are common optical fiber is used for the measurement reflected light and the circulating reference light.

As illustrated in FIG. 15, similarly to the optical measurement device according to the first embodiment, the optical measurement device according to the third embodiment includes a wavelength sweeping light source 1, a light dividing unit 2, an irradiation optical system 3, a circulating light path 4, a measurement signal acquisition unit 5 including a measurement position correction signal generator unit 6, and a signal processor unit 7.

Since the optical measurement device according to the third embodiment is different from the optical measurement device according to the first embodiment in that the optical measurement device according to the third embodiment uses a common light path interference system as described above, the measurement light path and the reference light path will be mainly described.

The measurement light path will be described.

Swept output light obtained by the light dividing unit 2 dividing swept light from the wavelength sweeping light source 1 is input to a coupler 41 of the circulating light path 4 via a common optical fiber. The swept output light input to the coupler 41 is directly input to the irradiation optical system 3 via a common optical fiber as measurement output light.

The measurement output light input to the irradiation optical system 3 is emitted into a space toward the measurement object 8 as measurement light. The irradiation optical system 3 receives reflected light obtained by the measurement object 8 reflecting the measurement light, and outputs the reflected light as measurement reflected light from the irradiation optical system 3 to the measurement signal acquisition unit 5 via a common optical fiber.

The reference light path will be described.

Swept output light obtained by the light dividing unit 2 dividing swept light from the wavelength sweeping light source 1 is input to the coupler 41 of the circulating light path 4 via a common optical fiber. The swept output light input to the coupler 41 is directly input to the irradiation optical system 3 via a common optical fiber as circulating reference light that has circulated 0 times.

In addition, the swept output light input to the coupler 41 circulates through a loop portion 42, and is input to the irradiation optical system 3 via a common optical fiber as circulating reference light every time the sweep output light circulates through the loop portion 42 from one time to N times.

The circulating reference light from the circulating light path 4 every time the sweep output light circulates through the loop portion 42 from zero times to N times is output to the measurement signal acquisition unit 5 via a common optical fiber via the irradiation optical system 3.

The swept output light from the light dividing unit 2 is input to the measurement signal acquisition unit 5 as the measurement reflected light and the circulating reference light via the common light path interference system as described above.

The measurement signal acquisition unit 5 operates similarly to the measurement signal acquisition unit 5 in the first embodiment by the input measurement reflected light and circulating reference light, and outputs an accurate measurement signal, a first (first wavelength region) rough measurement signal, and a second (second wavelength region) rough measurement signal.

The signal processor unit 7 that has received the accurate measurement signal from the measurement signal acquisition unit 5 performs accurate measurement operation similarly to the signal processor unit 7 in the first embodiment, and obtains a distance obtained by the measurement reflected light and the circulating reference light.

The signal processor unit 7 that has received the first rough measurement signal and the second rough measurement signal from the measurement signal acquisition unit 5 performs rough measurement operation similarly to the signal processor unit 7 in the first embodiment, and obtains the number of circulations.

The signal processor unit 7 obtains a distance to the measurement object 8 from the distance obtained by the measurement reflected light and the circulating reference light, obtained by the accurate measurement, and the number of circulations obtained by the rough measurement, and outputs the obtained distance.

The optical measurement device according to the third embodiment has a similar effect to that of the optical measurement device according to the first embodiment, and includes the measurement light path and the reference light path constituted by the common light path interference system, and therefore can suppress an influence of a temperature fluctuation of the common optical fiber on measurement of a distance to the measurement object 8.

### Fourth Embodiment

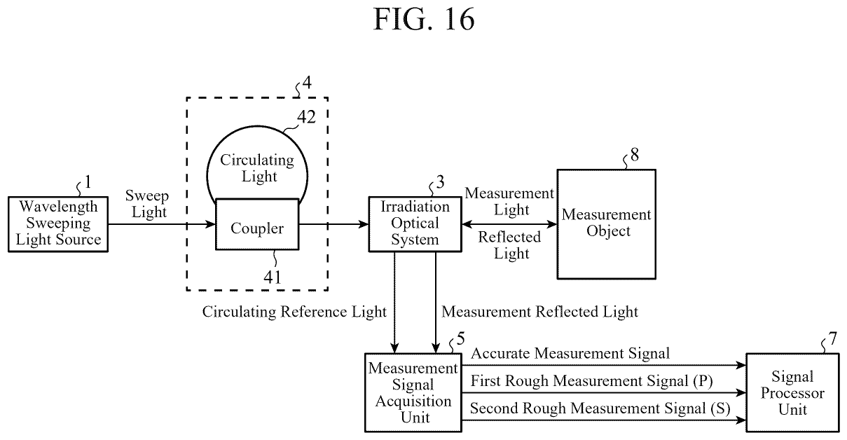

An optical measurement device according to a fourth embodiment will be described with reference to FIG. 16.

The optical measurement device according to the fourth embodiment is different from the optical measurement device according to the second embodiment in that the optical measurement device according to the fourth embodiment uses a common light path interference system, and the other points are the same or similar.

In FIG. 16, the same reference numerals as in FIG. 11 denote the same or corresponding portions.

In the optical measurement device according to the second embodiment, an optical fiber used in a measurement light path in which measurement output light is emitted as measurement light from the light dividing unit 2 through the irradiation optical system 3 toward the measurement object 8, and the emitted measurement light is reflected by the measurement object 8, passes through the irradiation optical system 3, and reaches the measurement signal acquisition unit 5 as measurement reflected light is different from an optical fiber used in a reference light path in which reference output light travels from the light dividing unit 2 to the measurement signal acquisition unit 5 as circulating reference light through the circulating light path 4.

Meanwhile, in the optical measurement device according to the fourth embodiment, a common light path interference system is used, and a common optical fiber is used for a measurement light path and a reference light path.

Note that, in FIG. 16, the measurement reflected light and the circulating reference light are separately illustrated, but are separately illustrated for convenience of description, and are common optical fiber is used for the measurement reflected light and the circulating reference light.

As illustrated in FIG. 16, similarly to the optical measurement device according to the second embodiment, the optical measurement device according to the fourth embodiment includes a wavelength sweeping light source 1, an irradiation optical system 3, a circulating light path 4, a measurement signal acquisition unit 5 including a rough measurement signal acquisition unit 9, and a signal processor unit 7.

Since the optical measurement device according to the fourth embodiment is different from the optical measurement device according to the second embodiment in that the optical measurement device according to the fourth embodiment uses a common light path interference system as described above, the measurement light path and the reference light path will be mainly described.

The measurement light path will be described.

Swept light from the wavelength sweeping light source 1 is input to a coupler 41 of the circulating light path 4 via a common optical fiber. The swept light input to the coupler 41 is directly input to the irradiation optical system 3 via a common optical fiber as measurement output light.

The measurement output light input to the irradiation optical system 3 is emitted into a space toward the measurement object 8 as measurement light. The irradiation optical system 3 receives reflected light obtained by the measurement object 8 reflecting the measurement light, and outputs the reflected light as measurement reflected light from the irradiation optical system 3 to the measurement signal acquisition unit 5 via a common optical fiber.

The reference light path will be described.

Swept light from the wavelength sweeping light source 1 is input to a coupler 41 of the circulating light path 4 via a common optical fiber. The swept light input to the coupler 41 is directly input to the irradiation optical system 3 via the common optical fiber as circulating reference light that has circulated 0 times.

In addition, the swept light input to the coupler 41 circulates through a loop portion 42, and is input to the irradiation optical system 3 via the common optical fiber as circulating reference light every time the sweep output light circulates through the loop portion 42 from one time to N times.

The circulating reference light from the circulating light path 4 for each circulation from zero times to N times is output to the measurement signal acquisition unit 5 via a common optical fiber via the irradiation optical system 3.

The swept light from the wavelength sweeping light source 1 is input to the measurement signal acquisition unit 5 as the measurement reflected light and the circulating reference light via the common light path interference system as described above.

The measurement signal acquisition unit 5 operates similarly to the measurement signal acquisition unit 5 in the second embodiment by the input measurement reflected light and circulating reference light, and outputs an accurate measurement signal, a first (P wave) rough measurement signal, and a second (S wave) rough measurement signal.

The signal processor unit 7 that has received the accurate measurement signal from the measurement signal acquisition unit 5 performs the accurate measurement operation similarly to the signal processor unit 7 in the second embodiment, and obtains the distance obtained by the measurement reflected light and the circulating reference light.

The signal processor unit 7 that has received the first rough measurement signal and the second rough measurement signal from the measurement signal acquisition unit 5 performs rough measurement operation similarly to the signal processor unit 7 in the second embodiment, and obtains the number of circulations.

The signal processor unit 7 obtains a distance to the measurement object 8 from the distance obtained by the measurement reflected light and the circulating reference light, obtained by the accurate measurement, and the number of circulations obtained by the rough measurement, and outputs the obtained distance.

The optical measurement device according to the fourth embodiment has a similar effect to that of the optical measurement device according to the second embodiment, and includes the measurement light path and the reference light path constituted by the common light path interference system, and therefore can suppress an influence of a temperature fluctuation of the common optical fiber with respect to measurement of a distance to the measurement object 8.

Note that the embodiments can be freely combined to each other, any constituent element in each of the embodiments can be modified, or any constituent element in each of the embodiments can be omitted.

### INDUSTRIAL APPLICABILITY

The optical measurement device according to the present disclosure is suitable for an optical measurement device that measures a distance to a measurement object in a processing apparatus and a semiconductor inspection apparatus.

### REFERENCE SIGNS LIST

1: Wavelength sweeping light source, 2: Light dividing unit, 3: Irradiation optical system, 4: Circulating light path, 5: Measurement signal acquisition unit (Measurement signal acquirer), 6: Measurement position correction signal generator unit, 7: Signal processor unit (Signal processor), 8: Measurement object, 9: Rough measurement signal acquisition unit

1. An optical measurement device comprising:
a wavelength sweeping light source to output swept light having a wavelength continuously changing with time;
an irradiation optical system to emit measurement output light caused by the swept light from the wavelength sweeping light source toward a measurement object into a space as measurement light, to receive reflected light obtained by the measurement object reflecting the measurement light, and to output the reflected light as measurement reflected light;
a circulating light path including a loop portion, to output circulating reference light for each circulation, in which reference output light caused by the swept light from the wavelength sweeping light source circulates through the loop portion N (an integer equal to or more than 0) times;
a measurement signal acquirer to combine the measurement reflected light from the irradiation optical system and the circulating reference light from the circulating light path, to output an accurate measurement signal obtained by photoelectrically converting the combined interference light, and to output a plurality of rough measurement signals including electric signals obtained using a plurality of circulating number measurement light beams having different refraction index dependencies with respect to a light path on a basis of the swept light; and
a signal processor to identify the number of circulations in the circulating light path of the circulating reference light, in which a light path length difference between the measurement reflected light and the circulating reference light is obtained by the accurate measurement signal from the measurement signal acquirer, and a light path length difference between the measurement reflected light and the circulating reference light is obtained by the plurality of rough measurement signals from the measurement signal acquirer.

2. The optical measurement device according to claim 1, wherein the plurality of circulating number measurement light beams having different refractive index dependencies with respect to the light path are light beams having a plurality of wavelength time dependencies based on the swept light.

3. The optical measurement device according to claim 1, wherein
the plurality of circulating number measurement light beams having different refractive index dependencies with respect to the light path are correction reference light beams having different wavelengths obtained by dividing the circulating reference light and correction reflected light beams having different wavelengths obtained by dividing the measurement reflected light, by a measurement position correction signal obtained by converting light beams divided into a plurality of different wavelengths within a sweep range of the swept light into electric signals, and
each of the plurality of rough measurement signals is a signal obtained by combining the correction reference light and the correction reflected light having a corresponding wavelength and photoelectrically converting the combined interference light.

4. The optical measurement device according to claim 1, wherein
the plurality of circulating number measurement light beams having different refractive index dependencies with respect to the light path are correction reference light beams having different wavelengths obtained by dividing the circulating reference light and correction reflected light beams having different wavelengths obtained by dividing the measurement reflected light, by a measurement position correction signal obtained by converting light beams divided into a plurality of different wavelengths within a sweep range of circulating reference light that has circulated zero times from the circulating light path into electric signals, and
each of the plurality of rough measurement signals is a signal obtained by combining the correction reference light and the correction reflected light having a corresponding wavelength and photoelectrically converting the combined interference light.

5. The optical measurement device according to claim 1, wherein
the swept light that is output from the wavelength sweeping light source and has a wavelength continuously changing with time is swept light that is laser light wavelength-swept to light in a plurality of wavelength regions by continuously changing a plurality of wavelength regions having different wavelength regions within a sweep range in a time-multiplexed manner,
the plurality of circulating number measurement light beams having different refractive index dependencies with respect to the light path are correction reference light beams having different wavelengths caused by circulating reference light with respect to each of the light beams in the plurality of wavelength regions output from the wavelength sweeping light source and correction reflected light beams having different wavelengths caused by measurement reflected light with respect to each of the light beams in the plurality of wavelength regions, and
each of the plurality of rough measurement signals is a signal obtained by combining the correction reference light and the correction reflected light having a corresponding wavelength and photoelectrically converting the combined interference light.

6. The optical measurement device according to claim 1, wherein
the plurality of circulating number measurement light beams having different refractive index dependencies with respect to the light path are correction reflected light and correction reference light separated into two polarized light beams orthogonal to the measurement reflected light and the circulating reference light, respectively, and
each of the plurality of rough measurement signals is a signal obtained by combining the correction reference light and the correction reflected light having a corresponding wavelength and photoelectrically converting the combined interference light.

7. The optical measurement device according to claim 1, wherein a light path of the measurement output light, the reference output light, and a light path of the circulating reference light to the irradiation optical system are a common light path, and a light path of the measurement reflected light and a light path of the circulating reference light from the irradiation optical system are a common light path.
